(19) United States
(12) Patent Application Publication
(10) Pub. No.: US 2018/0322545 A1
(43) Pub. Date: Nov. 8, 2018

(54) STORE DESIGN ASSISTANCE DEVICE AND STORE DESIGN ASSISTANCE METHOD

(71) Applicant: FUJIFILM Corporation, Tokyo (JP)

(72) Inventor: Makoto YONAHA, Tokyo (JP)

(73) Assignee: FUJIFILM Corporation, Tokyo (JP)

(21) Appl. No.: 16/032,255

(22) Filed: Jul. 11, 2018

Related U.S. Application Data
(63) Continuation of application No. PCT/JP2016/083740, filed on Nov. 15, 2016.

(30) Foreign Application Priority Data
Feb. 10, 2016 (JP) 2016-023814

(51) Int. Cl. G06Q 30/02; G06Q 30/06; G06F 17/30

(52) U.S. Cl. CPC G06Q 30/0281; G06Q 30/0627; G06Q 30/0643; G06F 17/30601; G06F 17/30309; G06Q 30/0631

(57) ABSTRACT

A store design assistance device and a store design assistance method for assisting in various designs of a real store according to a trend of consumers who are targets of a real store are provided. A store design assistance device includes a database, an attribute information acquisition unit that acquires second consumer attribute information indicating an attribute of a second consumer at a real store, a history information acquisition unit that acquires information on an action history of the first consumer having the first consumer attribute information matching the second consumer attribute information from the database, and an output unit that outputs information on design assistance of the real store on the basis of the information on the action history acquired by the history information acquisition unit.

### CROSS REFERENCE TO RELATED APPLICATIONS

This application is a Continuation of PCT International Application No. PCT/JP2016/083740 filed on Nov. 15, 2016, which claims priority under 35 U.S.C § 119(a) to Patent Application No. 2016-023814 filed in Japan on Feb. 10, 2016, all of which are hereby expressly incorporated by reference into the present application.

### BACKGROUND OF THE INVENTION

### 1. Field of the Invention

The present invention relates to a store design assistance device and a store design assistance method, and more particularly, to a store design assistance device and a store design assistance method in which consumer information is used at an electronic commerce site.

### 2. Description of the Related Art

In recent years, opportunities for products to be traded on an electronic commerce site (an EC site) on the Internet are increasing.

JP2002-183539A describes a technology for using information such as a purchase history of a consumer among a shopping site operator (A), a consumer (B), a clothing seller (C), and a clothing manufacturer (D) (FIG. 1).

JP1998-232898A (JP-H10-232898A) describes a technology in which a client computer is installed in a retailer, an apparel company, a manufacturer, and the like, order information or the like is transmitted from the client computer to a server, the transmitted order information or the like are stored in the server, and the stored information is used for adjustment of stocks or the like.

### SUMMARY OF THE INVENTION

Here, in a case where various designs of exhibits, purchase, an arrangement of shelves, an arrangement of store clerks in a store, and the like are performed, it is important to obtain information such as preference of consumers as targets of a store and perform various designs on the basis of the information. That is, it is possible to effectively improve sales of the store by performing a store design on the basis of information on consumers that are targets of the store. Here, the above-described store is a store in a real space (a real store) and, for example, it is necessary for geographical conditions such as different consumers according to a region where there is the real store, preference of consumers who are targets of the real store, and the like to be considered in various designs of the real store.

However, JP2002-183539A and JP10-232898A (JP-H10-232898A) do not mention performing various designs of the real store using information on consumers who are targets of the real store. That is, it may be difficult to effectively improve sales of the real store even in a case where various designs regarding the real store are performed using information also including information on consumers who are not targets of the real store, as in the technologies described in JP2002-183539A and JP10-232898A (JP-H10-232898A).

The present invention has been made in view of such circumstances, and an object of the present invention is to provide a store design assistance device and a store design assistance method for assisting in various designs of a real store according to a trend of consumers who are targets of the real store.

A store design assistance device according to an aspect of the present invention comprises a database in which first consumer attribute information indicating an attribute of a first consumer in an electronic commerce site and information on an action history of the first consumer are stored in association with each other; an attribute information acquisition unit that acquires second consumer attribute information indicating an attribute of a second consumer at a real store; a history information acquisition unit that acquires information on the action history of the first consumer having the first consumer attribute information matching the second consumer attribute information from the database; and an output unit that outputs information on design assistance of the real store on the basis of the information on the action history acquired by the history information acquisition unit.

According to this aspect, the information on the action history of the consumer of the electronic commerce site matching an attribute of a consumer (second consumer) at the real store is acquired, and the information on the design assistance of the real store is output on the basis of the acquired information on the action history. Accordingly, in the aspect, it is possible to assist in various designs of the real store according to a trend of consumers who are targets of the real store.

Preferably, the history information acquisition unit acquires preference information of the first consumer as the information on the action history, and the output unit outputs information on an arrangement of store clerks of the real store as the information on the design assistance of the real store.

According to this aspect, since the information on the arrangement of store clerks of the real store is output as the information on design assistance of the real store, it is possible to assist in a store design in which store clerks who can deal well with a preference of consumers who are targets of the real store are arranged.

Preferably, the first consumer attribute information and the second consumer attribute information include at least one of regional information, era information, or sex information.

According to this aspect, since the first consumer attribute information and the second consumer attribute information include at least one of regional information, era information, or sex information, it is more accurately acquire the information on the action history of consumers who are targets of the real store.

Preferably, the history information acquisition unit acquires information on a click rate of a product display as the information on the action history, and the output unit outputs information on a purchase design of a product at the real store as the information on design assistance of the real store.

According to this aspect, the information on a click rate of a product display is acquired as the information on the action history, and the information on a purchase design of a product at the real store is output as the information on design assistance of the real store. Accordingly, in the aspect, it is possible to assist in purchase of products according to a demand of consumers who are targets of the real store.

Preferably, the history information acquisition unit acquires information on a click rate of a product display posted on a top page of the electronic commerce site as the information on the action history, and the output unit outputs information on a design of storefront display products at the real store as the information on design assistance of the real store.

According to this aspect, the information on a click rate of a product display posted on a top page of the electronic commerce site is acquired as the information on the action history, and information on a design of storefront display products at the real store is output as the information on design assistance of the real store. Accordingly, in the aspect, it is possible to assist in a design of favorite storefront display products of consumers who are targets of the real store.

Preferably, the history information acquisition unit acquires information on a click rate with respect to coordinated products display as the information on the action history, and the output unit outputs coordinated exhibition information at the real store as the information on design assistance of the real store.

According to this aspect, the information on the click rate with respect to the coordinated product display is acquired as the information on the action history and coordinated exhibition information at the real store is output as the information on design assistance of the real store. Accordingly, in the aspect, it is possible to exhibit favorite coordinated products of consumers who are targets of the real store.

Preferably, the history information acquisition unit acquires information on an order in which the products are viewed or coordinated as the information on the action history, and the output unit outputs information on an arrangement of shelves or an arrangement of products at the real store as the information on design assistance of the real store.

According to this aspect, the information on the order in which the products are viewed or coordinated is acquired as the information on the action history, and the information on the arrangement of shelves or the arrangement of products at the real store are output as the information on design assistance of the real store. Accordingly, in this aspect, it is possible to assist in a design of the arrangement of shelves or the arrangement of products according to a trend of the consumers who are target of the real store.

Preferably, the history information acquisition unit acquires information on a click rate with respect to a link of a product other than products handled by the electronic commerce site as the information on the action history, and the output unit outputs information on a design of a novelty product as the information on design assistance of the real store.

According to this aspect, the information on a click rate with respect to a link of a product other than products handled by the electronic commerce site is acquired as the information on the action history, and the information on a design of a novelty product is output. Accordingly, in this aspect, it is possible to assist in the design of the novelty product according to preference of consumers that are targets of a real store.

A store design assistance method according to another aspect of the present invention is a store design assistance method in which a database in which first consumer attribute information indicating an attribute of a first consumer in an electronic commerce site and information on an action history of the first consumer are stored in association with each other is used, the store design assistance method comprising steps of: acquiring second consumer attribute information indicating an attribute of a second consumer at a real store; acquiring information on the action history of the first consumer having the first consumer attribute information matching the second consumer attribute information from the database; and outputting information on design assistance of the real store on the basis of the information on the action history.

According to the present invention, since the information on the action history of the consumer of the electronic commerce site matching an attribute of a consumer at the real store is acquired, and the information on the design assistance of the real store is output on the basis of the acquired information on the action history, it is possible to assist in various designs of the real store according to a trend of consumers who are targets of the real store.

### BRIEF DESCRIPTION OF THE DRAWINGS

FIG. 1 is a conceptual diagram illustrating an example of a use form of a store design assistance device.

FIG. 2 is a perspective view illustrating an appearance configuration of a user terminal.

FIG. 3 is a block diagram illustrating a system configuration of a user terminal.

FIG. 4 is a diagram illustrating functional blocks of a store design assistance device.

FIG. 5 is a table showing a storage configuration example of a product database.

FIG. 6 is a diagram illustrating a language image scale showing sensitivity words arranged in a sensitivity space.

FIG. 7 is a diagram illustrating a single-color image scale of single-colors (130 colors) arranged in a sensitivity space.

FIG. 8 is a table showing a storage configuration example of a consumer database.

FIG. 9 is a diagram illustrating a correspondence table between information on an EC site and information on a real store.

FIG. 10 is an example of information on design assistance of a real store.

FIG. 11 is a diagram illustrating an operation flow of a store design assistance device.

FIG. 12 is an example of information on design assistance of a real store.

FIG. 13 is a diagram illustrating a coordination No.

FIG. 14 is an example of information on design assistance of a real store.

FIG. 15 is a diagram illustrating a flow line No.

FIG. 16 illustrates an example of information on design assistance of a real store.

FIG. 17 is a diagram illustrating a link No.

FIG. 18 illustrates an example of information on design assistance of a real store.

FIG. 19 is a diagram illustrating a preference type No.

### DESCRIPTION OF THE PREFERRED EMBODIMENTS

Hereinafter, embodiments of a store design assistance device and a store design assistance method of the present invention will be described with reference to the accompanying drawings. In the following embodiments, various designing actions of a “store handling clothes” will be described, but a real store targeted by the present invention is not limited to the “store handling clothes”, but the present invention can also be applied to real stores handling other products. Further, in examples that will be described below, it is assumed that a “first consumer” is a “consumer of an electronic commerce site” and a “second consumer” is a “consumer of a real store”. Therefore, “first consumer attribute information” is “attribute information of a consumer of the electronic commerce site” and “second consumer attribute information” is “attribute information of a consumer of the real store”.

Here, the electronic commerce site (EC site) is a web site of the internet where trading of products is performed. A consumer of the electronic commerce site can purchase products at the electronic commerce site by connecting to the Internet. In addition, the real store refers to a store installed in a real building and refers to a store at which products are purchased and sold. Since the consumer of the real store actually goes to that store to purchase products, the consumer often goes to a store located in a living zone of the consumer (for example, near a residence or a workplace).

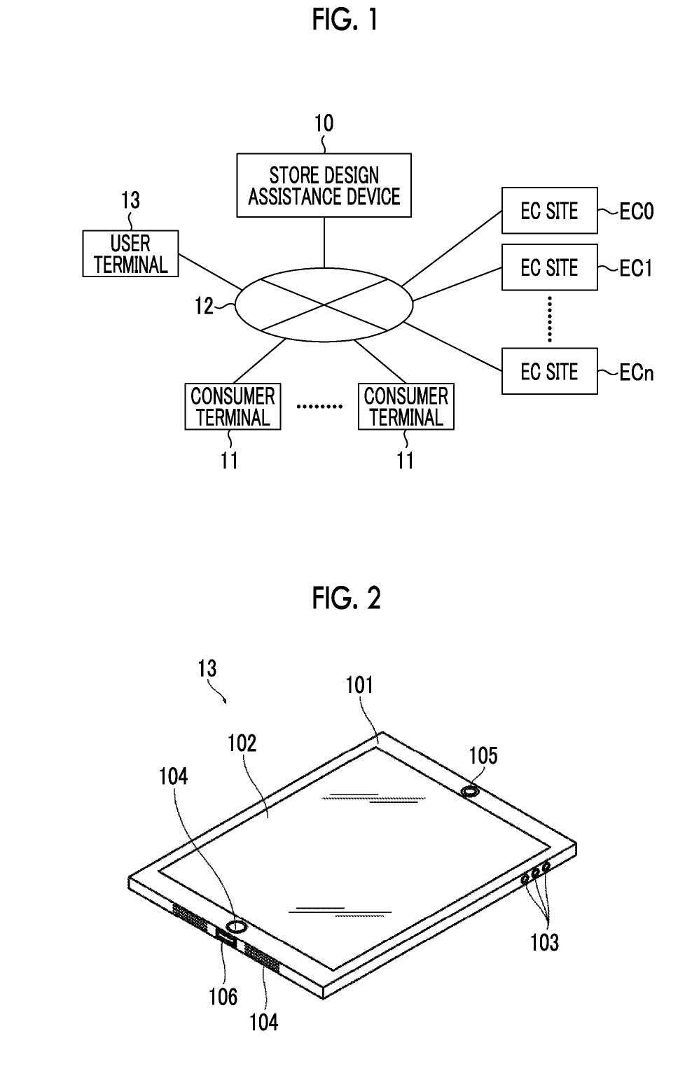

FIG. 1 is a conceptual diagram illustrating an example of a use form of a store design assistance device of the present invention. In the illustrated use form, a store design assistance device 10, a plurality of consumer terminals 11, and a plurality of electronic commerce sites EC0 to ECn are connected via a network 12 such as the Internet.

The store design assistance device 10 accumulates and stores a purchase history of products of the EC sites (EC0 to ECn) that consumers purchase using the consumer terminal 11 over the network 12, and a history of viewing or the like (for example, selection of a product image or coordination operation) of products of the EC sites (EC0 to ECn) performed by the consumers using the consumer terminal 11. The store design assistance device 10 can acquire the purchase history, the viewing history, and the like in the consumer terminal 11 using a known method. For example, the consumer terminal 11 searches for and purchases products handled by the EC sites (EC0 to ECn) via the store design assistance device 10, and the store design assistance device 10 acquires the purchase history and the viewing history of the consumer terminal 11.

The EC sites (EC0 to ECn) include a function of providing information on products (for example, product images, brands, stocks, prices, sizes, recommended products, and purchase information) to the user accessing the EC sites from the consumer terminal 11 via the store design assistance device 10 or providing information on the products handled by the EC sites to a user accessing the EC sites without passing through the store design assistance device 10.

The consumer terminal 11 is a terminal that is operated by a consumer in a case where the consumer searches for or purchases products such as a suit.

The user terminal 13 is a terminal that is used by a user of the store design assistance device 10. The user of the store design assistance device 10 is, for example, an owner of a real store or a designer of the real store. The user operates the user terminal 13 to receive provided assistance of various designs of the real store.

It should be noted that the consumer terminal 11 and the user terminal 13 are portable terminals such as smart phones or tablet devices, personal computers, or the like.

Next, the consumer terminal 11 and the user terminal 13 will be described. Since the consumer terminal 11 and the user terminal 13 have the same configuration, the user terminal 13 will mainly be described herein.

FIG. 2 is a perspective view illustrating an appearance configuration of the user terminal 13, and is a front perspective view.

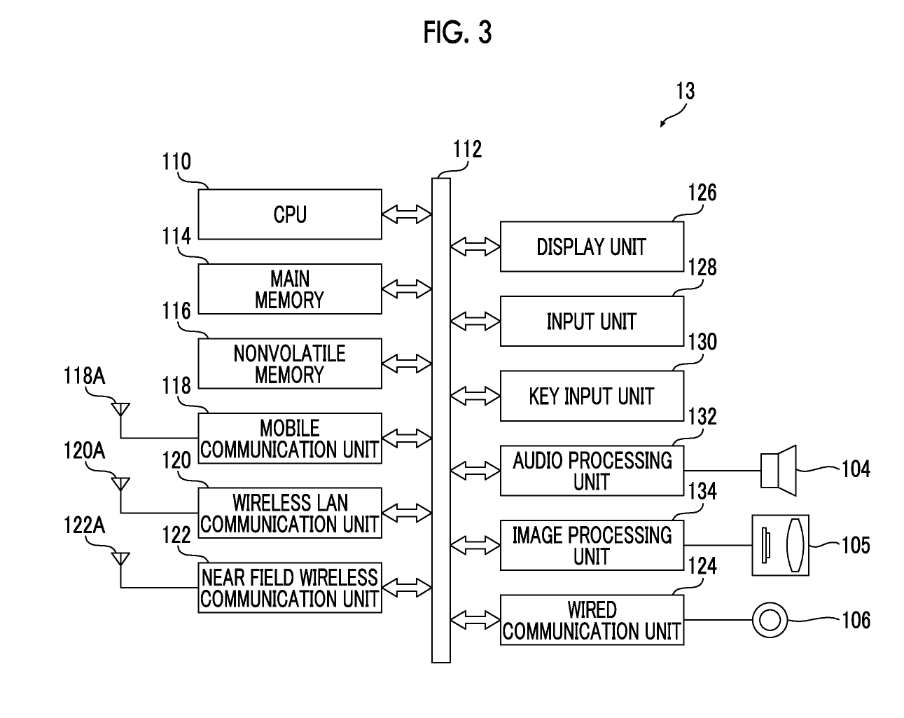

As illustrated in FIG. 2, the user terminal 13 is configured of a tablet type computer. The user terminal 13 includes a flat casing 101 having a rectangular outline, and is configured to include a touch panel display 102 serving as both a display unit 126 (FIG. 3) and an input unit 128 (FIG. 3), an operation button 103, a speaker 104, a built-in camera 105, an external connection terminal 106, and the like in casing 101.

FIG. 3 is a block diagram illustrating a system configuration of the user terminal 13.

As illustrated in FIG. 3, the user terminal 13 includes a central processing unit (CPU) 110 that controls an overall operation of the user terminal 13, and is configured such that a main memory 114, a nonvolatile memory 116, a mobile communication unit 118, a wireless LAN (LAN: Local Area Network) communication unit 120, a near field wireless communication unit 122, a wired communication unit 124, a display unit 126, an input unit 128, a key input unit 130, an audio processing unit 132, an image processing unit 134, and the like are connected to the CPU 110 via a system bus 112.

The CPU 110 functions as a control unit that controls an operation of the entire computer by reading an operation program (an operating system (OS)), an application program that is operated on the OS, standard data, and the like stored in the nonvolatile memory 116, developing these in the main memory 114, and executing the operation program.

The main memory 114 is configured of, for example, a random access memory (RAM), and functions as a work memory of the CPU 110.

The nonvolatile memory 116 is configured of, for example, a flash EEPROM (Electrically Erasable Programmable Read Only Memory), and stores the above-described operation program and various types of standard data. Further, the nonvolatile memory 116 functions as a storage unit of the user terminal 13 and stores various types of data.

The mobile communication unit 118 executes transmission and reception of data to and from the nearest base station (not illustrated) via an antenna 118A on the basis of a third-generation mobile communication system conforming to the IMT-2000 standard (International Mobile Telecommunication-2000) and a fourth-generation mobile communication system conforming to the IMT-Advance standard (International Mobile Telecommunications-Advanced).

The wireless LAN communication unit 120 performs wireless LAN communication according to a predetermined wireless LAN communication standard (for example, an IEEE 802.11 a/b/g/n standard), with a wireless LAN access point or an external device capable of wireless LAN communication, via an antenna 120A.

The near field wireless communication unit 122 executes transmission and reception of data to and from, for example, another device conforming to a Bluetooth (registered trademark) standard that is in a range of Class 2 (within a radius of about 10 m) via the antenna 122A.

The wired communication unit 124 performs communication according to a predetermined communication standard with an external device connected using a cable via the external connection terminal 106. For example, universal serial bus (USB) communication is performed.

The display unit 126 includes a color LCD (LCD: Liquid Crystal Display) panel which constitutes a display portion of the touch panel display 102, and a driving circuit thereof, and displays various images.

The input unit 128 constitutes a touch panel portion of the touch panel display 102. The input unit 128 is configured integrally with the color LCD panel using transparent electrodes. The input unit 128 generates and outputs two-dimensional position coordinate information corresponding to a touch operation of a user.

The key input unit 130 includes a plurality of operation buttons 103 included in the casing 101 of the user terminal 13, and a driving circuit thereof.

The audio processing unit 132 converts digital audio data provided via the system bus 112 into an analog signal and outputs the analog signal from the speaker 104.

The image processing unit 134 digitizes an analog image signal output from the built-in camera 105 including an imaging lens and an image sensor, performs required signal processing on a resultant signal, and outputs the signal.

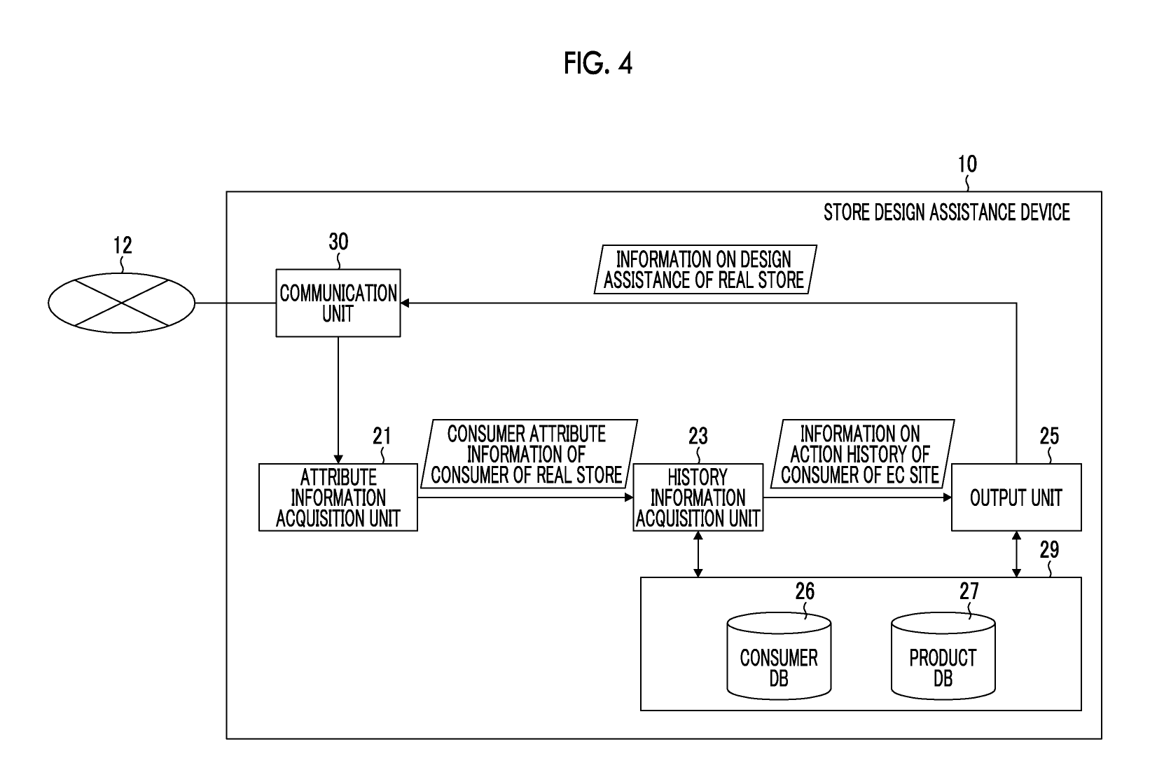

FIG. 4 is a diagram illustrating functional blocks of the store design assistance device 10. The store design assistance device 10 mainly includes an attribute information acquisition unit 21, a history information acquisition unit 23, an output unit 25, a database 29, and a communication unit 30. The store design assistance device 10 is configured of a general server or the like, and the attribute information acquisition unit 21, the history information acquisition unit 23, the output unit 25, the database 29, and the communication unit 30 are controlled by one or a plurality of internal CPUs being operated. Further, the database 29 is constructed on a recording medium such as a hard disk drive (HDD) using a known language such as SQL. It should be noted that the user terminal 13, the consumer terminal 11, and the EC site are connected to the network 12 in addition to the store design assistance device 10 as described with reference to FIG. 1, but are omitted.

The communication unit 30 has an input function and an output function, and performs an input of various types of information to the store design assistance device 10 and an output of information from the store design assistance device 10. For example, consumer attribute information of consumers at a real store is input from the network 12 to the communication unit 30, and the communication unit 30 transmits the input consumer attribute information to the attribute information acquisition unit 21. Further, for example, the communication unit 30 receives information on the design assistance of the real store output from the output unit 25 and transmits the information to the user terminal 13 over the network 12. Here, the information on the design assistance of the real store refers to information useful in a case where various designs of the real store are performed.

The attribute information acquisition unit 21 acquires the consumer attribute information indicating attributes of a consumer at the real store. That is, the user of the store design assistance device 10 inputs the consumer attribute information on the consumer at the real store to be designed, using the user terminal 13, and the attribute information acquisition unit 21 acquires the consumer input attribute information over the network 12. Here, the consumer attribute information is information including at least one of regional information, era information, or sex information of the consumer. The regional information of the consumer is a residence of the consumer, a place of work, a shopping area, or the like, and is information on places in a living zone of the consumer. It should be noted that the regional information may be information having a range to indicate a region within 30 km from Tokyo, for example.

In addition, the era information is information on an age or an era of the consumer. In addition, the sex information is information on a sex of a consumer. The attribute information acquisition unit 21 transmits the acquired consumer attribute information of the consumer at the real store to the history information acquisition unit 23.

The history information acquisition unit 23 acquires information on the action history of the consumer of the EC site having consumer attribute information matching the consumer attribute information of the consumer at the real store from the database 29. For example, in a case where the history information acquisition unit 23 acquires regional information (an address, a work place, or a shopping area) as the consumer attribute information of the consumer at the real store, the history information acquisition unit 23 acquires the action history of the consumer of the EC site having regional information matching such regional information. Further, for example, in a case where the history information acquisition unit 23 acquires the era information as the consumer attribute information of the consumer at the real store, the history information acquisition unit 23 acquires the action history of the consumer of the EC site having era information matching such era information. Further, for example, in a case where the history information acquisition unit 23 acquires the sex information as the consumer attribute information of a consumer at the real store, the history information acquisition unit 23 acquires an action history of the consumer of the EC site having sex information matching such sex information.

The database 27 mainly includes a consumer database (described as a consumer DB in FIG. 4) 26 and a product database (described as a product DB in FIG. 4) 27.

In the consumer database 26, consumer attribute information indicating the attributes of the consumer at the EC site and information on the action history are stored in association with each other. In the product database 27, a design feature amount of a product obtained by analyzing a product image showing a product and information on a sales record of the product are registered in association with each other for each product.

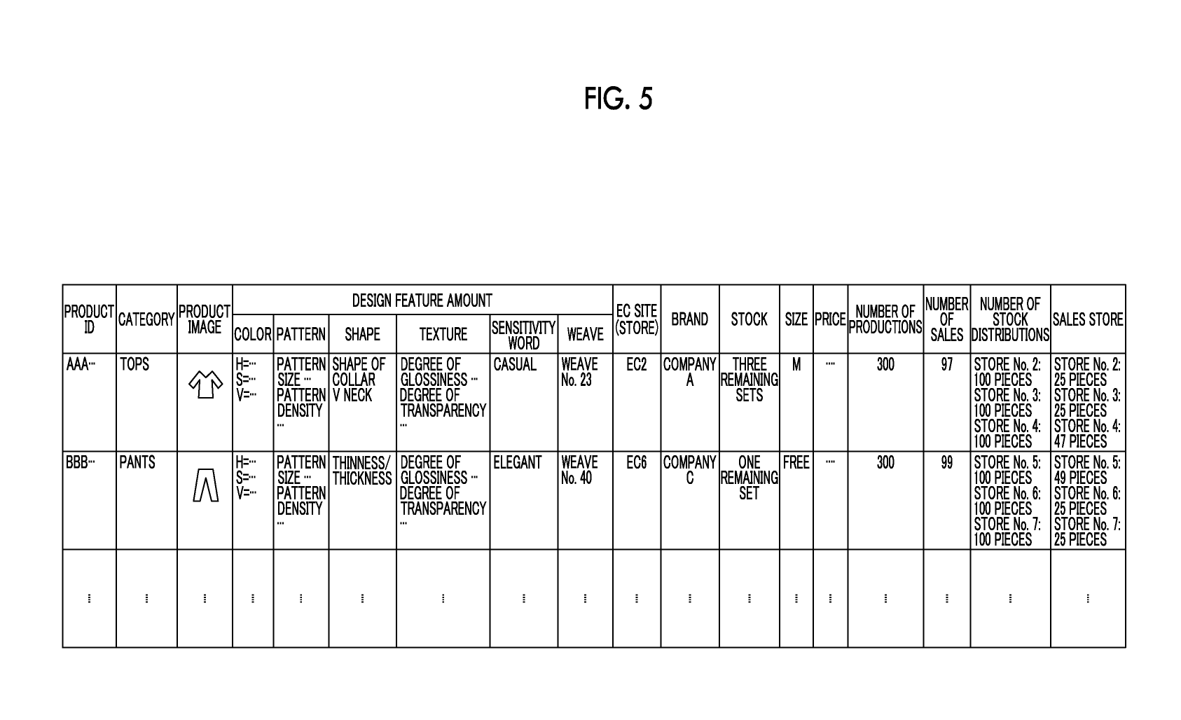

FIG. 5 illustrates a storage configuration example of the product database 27.

The product database 27 registers and manages information on products for each product. The product database 27 stores category information of a product, image data of the product, a design feature amount (a physical measurement value such as a color feature amount, a pattern feature amount, a shape feature amount, and a texture feature amount, a sensitivity word, and a weave) obtained by analyzing an image of the product, site information indicating an EC site, brand information, stock information, size (for example, S, M, L or free) information, price information, the number of productions, the number of sales, sales store information at the EC site, and the number of stock distributions in association with each other using a product identification (ID) for specifying the product as a key. It should be noted that the number of stock distributions is the number of stock deliveries, and the number of stock distributions may be indicated by proportion (delivery proportion).

Here, the product ID is intended to uniquely specify the product. For example, a product (a clothing) having the same a color, a pattern, a shape, and a texture influencing an image thereof may be regarded as the same product and the same product ID may be imparted to the product, or the same product ID may be imparted to a product having a different color and the same pattern, shape, and texture.

The category information indicates categories of products (clothes), and is information including tops, pants, blouses, skirts, T-shirts, and dresses.

It should be noted that information on the products registered in the product database 27 can be collected from EC sites, with the design feature amount excluded, and the design feature amount is acquired by an image analysis unit (not illustrated) of the store design assistance device 10 analyzing image data of the product and is imparted as a part of the product information. Specifically, the design feature amount is acquired by performing image analysis using a discriminator obtained by a machine learning method such as SVM, Real AdaBoost, or AdaBoost, and a feature amount such as a wavelet feature amount, a Haar-like feature amount, an Edgelet feature amount, an EOH feature amount, or a HOG feature amount.

In addition, the sensitivity word included in the design feature amount can be obtained on the basis of the physical measurement value obtained by analyzing the image data of the product.

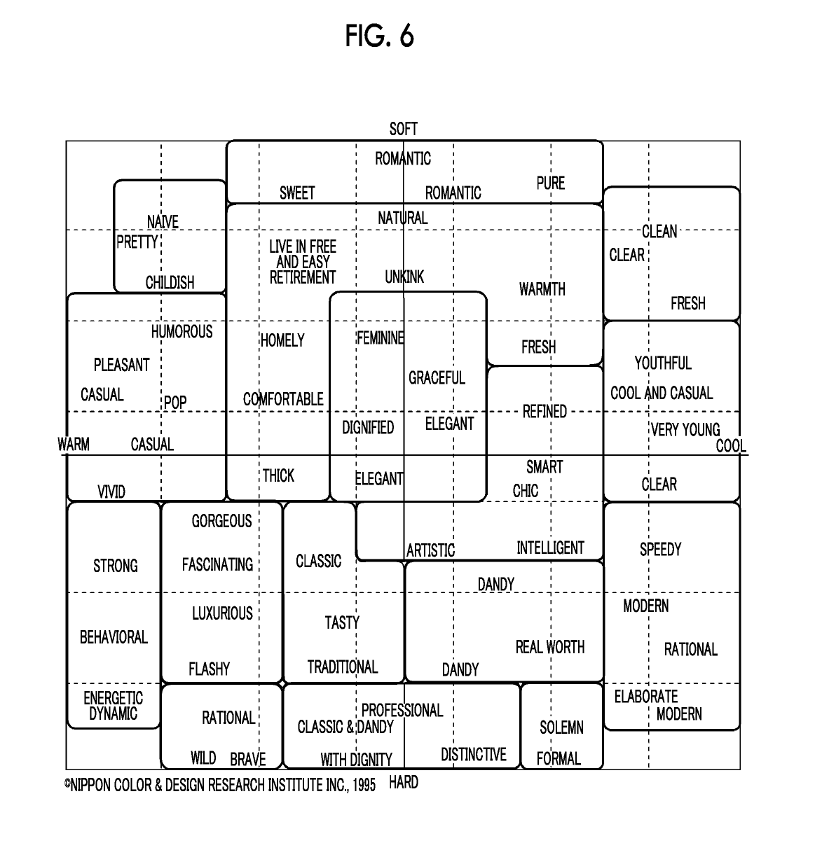

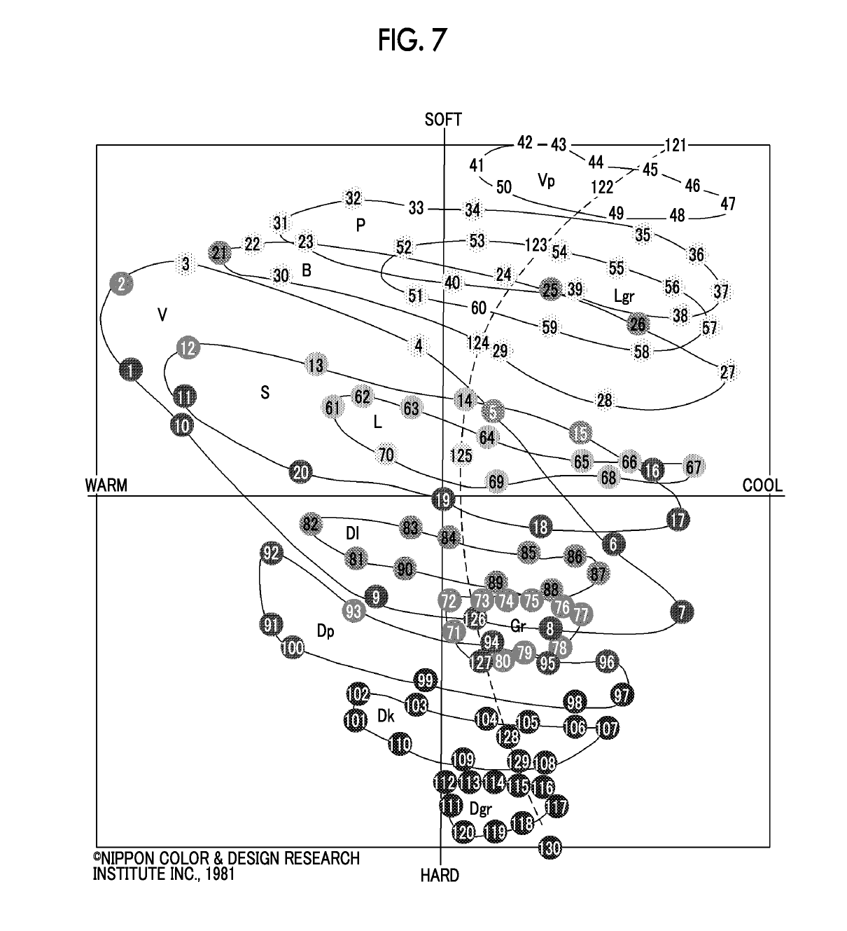

FIG. 6 is a language image scale showing sensitivity words arranged in a sensitivity space, and FIG. 7 is a single-color image scale of single colors (130 colors) arranged in the sensitivity space. It should be noted that the image scale illustrated in FIGS. 6 and 7 indicates an image scale disclosed from Nippon Color & Design Research Institute Inc. (see Shigenobu Kobayashi, “Color System” (Kodansha), and

http://www.ncd-ri.co.jp/about/image_system.html).

The sensitivity space illustrated in FIGS. 6 and 7 is a space defined by a horizontal axis indicating a degree of WARM/COOL and a vertical axis indicating a degree of HARD/SOFT.

In the language image scale illustrated in FIG. 6, 64 sensitivity words are arranged in the sensitivity space. Further, in the single-color image scale illustrated in FIG. 7, 130 single colors are arranged in the sensitivity space. Respective symbols illustrated in FIG. 7 indicate V (vivid), S (strong), B (bright), P (pale), Vp (berth⋅pale), Lgr (light grayish), L (light), Gr (grayish), Dl (dull), Dp (deep), Dk (dark), and Dgr (dark grayish). Further, as representative colors among the 130 colors indicated by numerals, 1 indicates red, 2 indicates orange, 3 indicates yellow, 4 indicates yellowish green, 5 indicates green, 6 indicates bluish green, 7 indicates blue, 8 indicates bluish purple, 9 indicates purple, and 10 indicates purplish red. In addition, 121 indicates white and 130 indicates black.

It is seen that there is a correlation between the sensitivity word and the physical measurement value (single color in the example of FIG. 7), as illustrated in FIGS. 6 and 7. Therefore, a conversion table or a conversion equation showing a relationship between the physical measurement value and the sensitivity word can be prepared in advance, an image of the product can be analyzed, the physical measurement value can be measured, and the measured physical measurement value can be converted into a sensitivity word using the conversion table or the like.

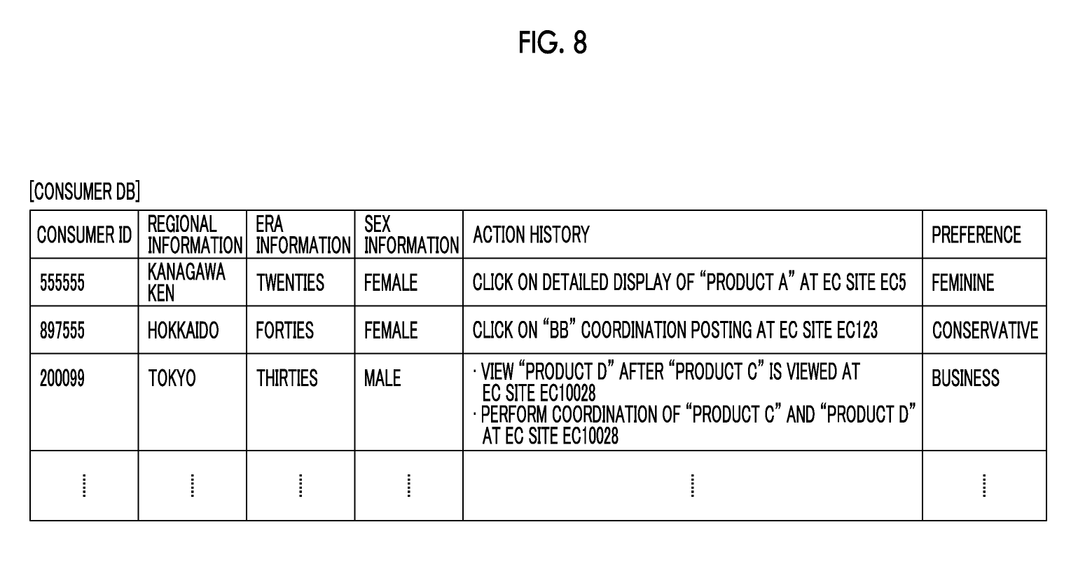

FIG. 8 illustrates a storage configuration example of the consumer database 26.

The consumer database 26 registers and manages consumer attribute information for each consumer. Using a consumer ID for specifying a consumer as a key, regional information such as information on a living zone such as a residence of consumers, era information such as information on an age of consumers, sex information on a sex of the consumers, an action history of the consumers at the EC site, and preference information of the consumers are stored in association with each other. Here, the preference information is information indicating the preference of the consumer, and particularly, information indicating the preference for the product.

Here, the action history at the EC site of the consumer is information on various operations that are performed by the consumer on the EC site. For example, the action history includes viewing (clicking) of a detailed display of products posted on the EC site, selecting (clicking) of a product image (a single product or coordinated products) posted on a top page of the EC site, selecting (clicking) of coordinated products, an order in which products are viewed or coordinated, and selecting of products other than products handled by the EC site. It should be noted that the action history is not limited thereto, and various action histories of consumers can be recorded.

Further, the preference information of the consumer is, for example, information such as a fashion which the consumer is interested in. The preference information of the consumer may be determined and assigned according to the action history of the consumer, or the consumer himself or herself may input the preference information, which is then stored.

Referring back to FIG. 4, the output unit 25 outputs the information on the design assistance of the real store on the basis of the information on the action history acquired by the history information acquisition unit 23. That is, the output unit 25 acquires the information on the action history of the consumer of the EC site having the consumer attribute information matching the consumer who is a target of the real store, and outputs the information on the design assistance of the real store on the basis of the information on the action history.

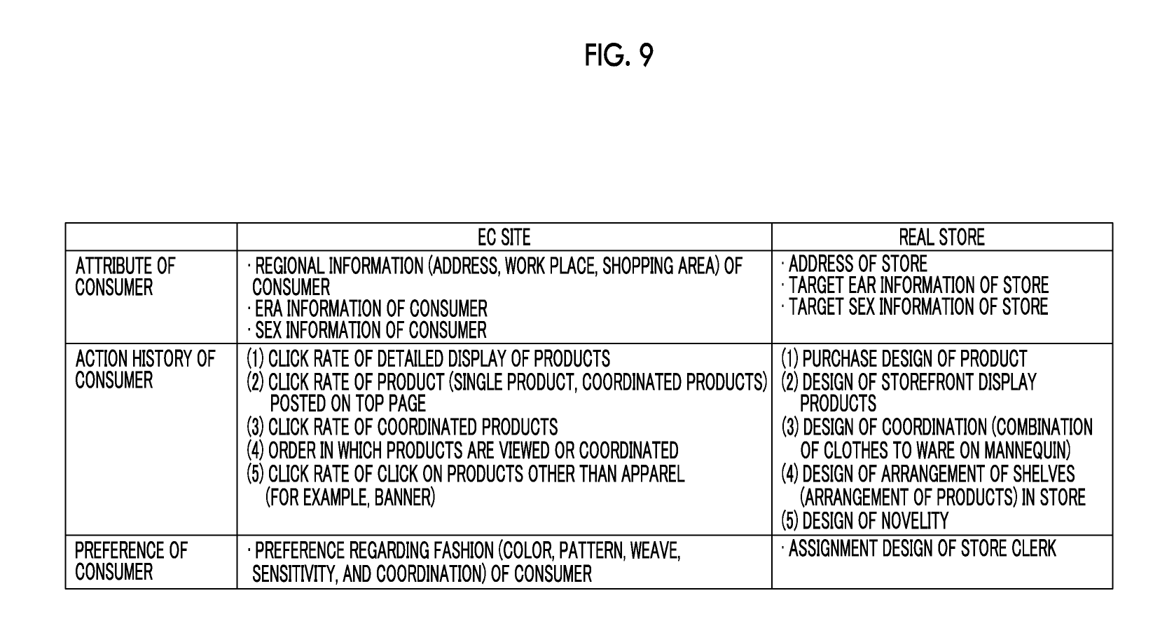

FIG. 9 is a diagram illustrating a correspondence table between the information on the EC site possessed by the output unit 25 and the information on the real store. Using the correspondence table illustrated in FIG. 9, the output unit 25 outputs information on the design assistance of the real store on the basis of the information on the action history of the consumer.

For the information on the design assistance of the real store output by the output unit 25, information of a type selected according to a user's instruction or preset is output. For example, in a case where the user instructs outputting of information on assistance of a purchase design of a product via the input unit 128 of the user terminal 13, the output unit 25 outputs information on a click rate of a detailed product display from the action history of the consumer having the matching consumer attribute information according to the instruction. Specifically, the output unit 25 acquires the design feature amount of the product that has been displayed in detail from the product database 27 and outputs the information on assistance of a purchase design of the product.

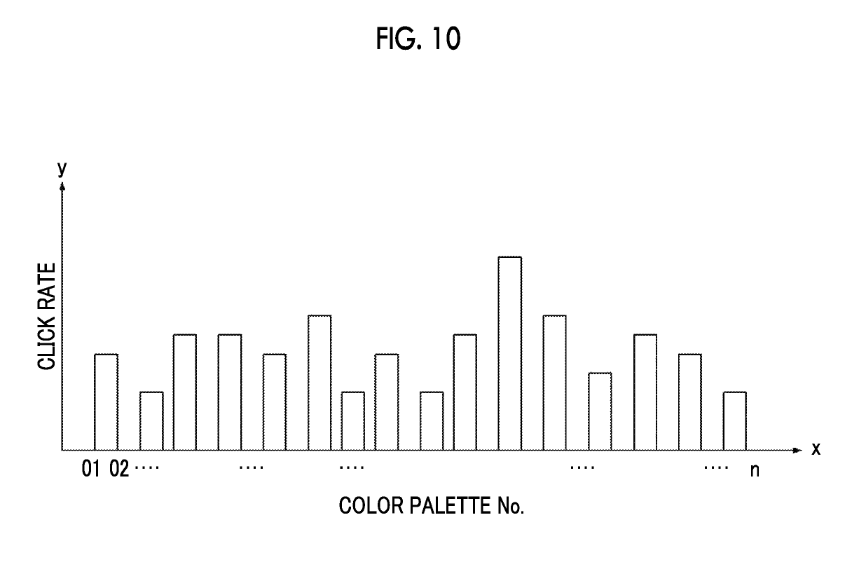

FIG. 10 illustrates an example of the information on the design assistance of the real store that is output by the output unit 25. In the graph illustrated in FIG. 10, an x-axis indicates color palette No and a y-axis indicates the click rate. Here, the click rate indicates, for example, a ratio of the number of selection clicks of each color to a total number of selection clicks of colors. In addition, the color palette No uniquely indicates a color and is a number assigned to each color. The color palette is a thumbnail display of the color palette. The user can display a graph as illustrated in FIG. 10 on the display unit 126 of the user terminal 13 and perform a purchase design of the product at the real store by referring to the graph. That is, the user can perform a purchase design according to the demand of the consumer who is a target of the real store by purchasing the product with a color palette having a high click rate by referring to the graph of FIG. 10.

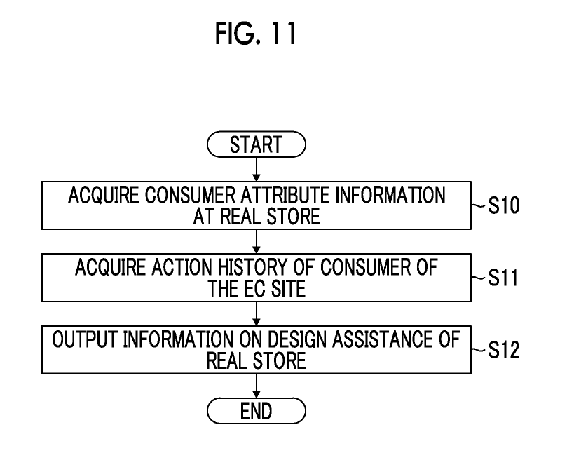

FIG. 11 is a diagram illustrating an operation flow of the store design assistance device 10.

First, the attribute information acquisition unit 21 acquires the attribute information of the consumer who is a target of a real store at which the user performs various designs (step S10). For example, the user inputs the attribute information via the user terminal 13, and the attribute information acquisition unit 21 acquires the consumer attribute information via the network 12 and the communication unit 30. Thereafter, the attribute information acquisition unit 21 transmits the acquired consumer attribute information to the history information acquisition unit 23. The history information acquisition unit 23 acquires the action history of the consumer of the EC site having the consumer attribute information matching the consumer attribute information acquired from the attribute information acquisition unit 21 (step S11). The history information acquisition unit 23 transmits information on the acquired action history to the output unit 25. Thereafter, the output unit 25 outputs information on design assistance of the real store selected on the basis of an instruction from the user terminal 13 or set in advance, on the basis of the acquired information on the action history (step S12).

Each configuration and function described above can be appropriately realized by any hardware, any software, or a combination of both. For example, the present invention can also be applied to a program causing a computer to execute the processing steps (processing procedures) described above, a computer-readable recording medium (non-temporary recording medium) having such a program recorded thereon, or a computer in which such a program can be installed.

Next, an example of the information on the design assistance of the real store output from the output unit 25 will be described.

### First Example

A first example of the information on the design assistance of the real store output by the output unit 25 is a case where the output unit 25 receives an instruction regarding a design of an exhibition of coordinated products of the real store from the user terminal 13.

In a case where the history information acquisition unit 23 acquires the information on the click rate with respect to the coordinated product display as the information on the action history, the output unit 25 outputs the coordinated exhibition information at the real store as the information on the design assistance of the real store. Here, the coordinated exhibition information is information on the coordinated products exhibited.

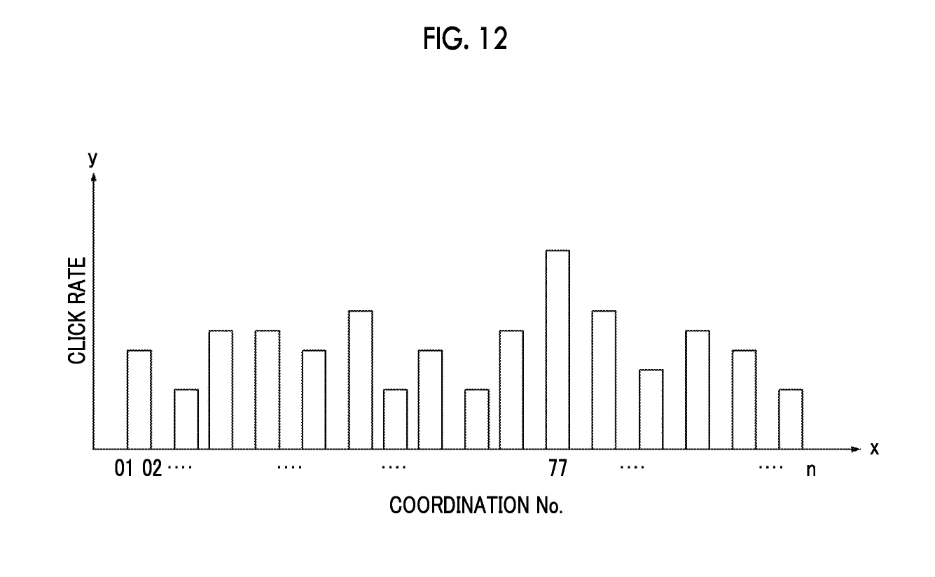

FIG. 12 is a graph showing the coordinated exhibition information, which is output from the output unit 25 and displayed on the display unit 126 of the user terminal 13. In FIG. 12, an x-axis indicates coordination No and a y-axis indicates the click rate.

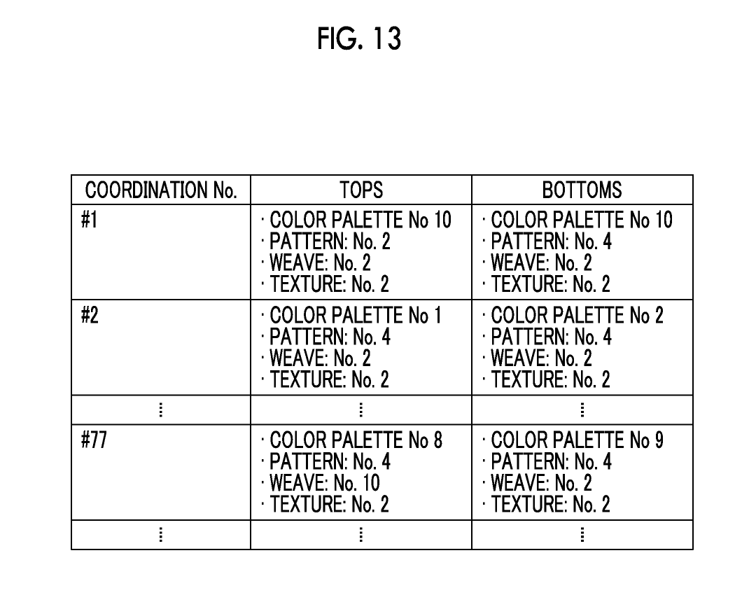

Further, FIG. 13 is a conceptual diagram illustrating a design feature amount (a color, a pattern, a weave, and a texture) of tops and a design feature amount of bottoms with respect to the coordination No illustrated in FIG. 12. As illustrated in FIG. 13, a combination of tops and bottoms is associated with each coordination No, and each of the tops and the bottoms has the design feature amount.

For example, the user performs exhibition of a product with the same coordination as coordination No 77 at the real store in consideration of a click rate of coordination No 77 being high. Also, the user may exhibit not only the same product as coordination No 77, but also tops and bottoms having the same design feature amount as coordination No 77, as the coordination, at the real store.

Accordingly, the user can exhibit coordinated products according to the preference of the consumer who is a target of the real store.

It should be noted that FIGS. 12 and 13 show an example of coordination between tops and bottoms, but the above-described description is also applied to a single product. That is, the history information acquisition unit 23 acquires information on the click rate of the product display posted on the top page at the EC site as the information on the action history, and the output unit 25 outputs information on the design of storefront display products at the real store, as the information on design assistance of the real store, on the basis of the correspondence table.

### Second Example

A second example of the information on the design assistance of the real store output by the output unit 25 is a case where the output unit 25 receives an instruction regarding a design of an arrangement of shelves or a product arrangement of the real store from the user terminal 13.

The history information acquisition unit 23 acquires information on an order in which products have been viewed or an order in which the products have been coordinated as the information on the action history, and the output unit 25 outputs information on an arrangement of shelves or an arrangement of products at the real store as the information on the design assistance of the real store.

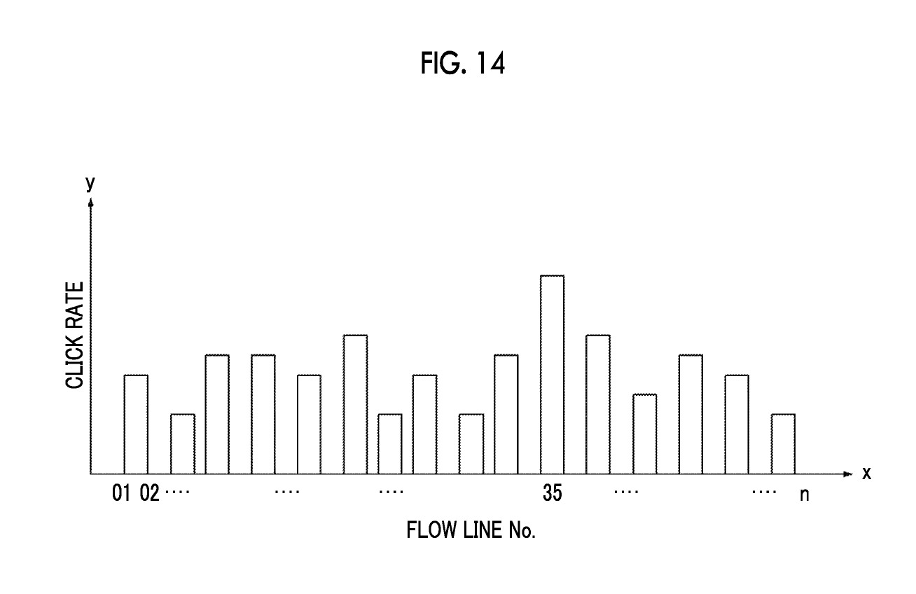

FIG. 14 is a graph of information on an arrangement of shelves or an arrangement of products, which is output from the output unit 25 and displayed on the display unit 126 of the user terminal 13. In FIG. 14, an x-axis indicates a flow line No and a y-axis indicate a click rate.

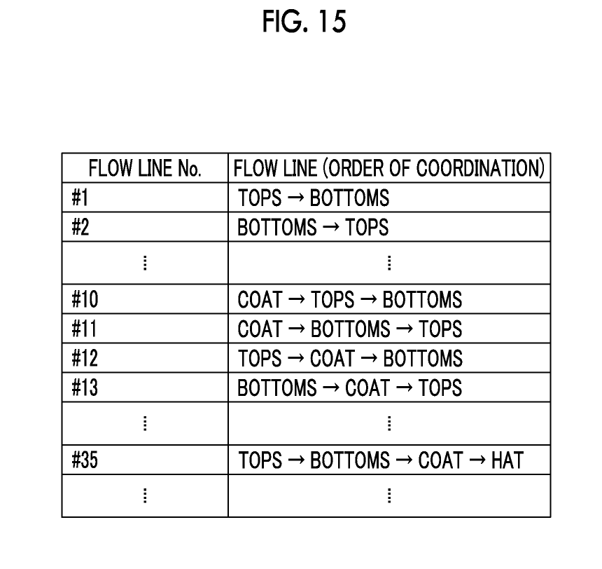

FIG. 15 is a conceptual diagram illustrating a flow line regarding a flow line No illustrated in FIG. 14. As illustrated in FIG. 15, an order of products is assigned to each flow line No.

For example, the user performs a design of a flow line similar to flow line No 35 at the real store in consideration of the click rate of flow line No 35 being high. That is, the user can perform a design of the real store so that an arrangement of shelves or an arrangement of the products of the real store is performed in an order of tops, bottoms, coats, and hats, such that the design of the real store corresponding to a trend of consumers who are targets of the real store can be performed.

### Third Example

A third example of the information on the design assistance of the real store output by the output unit 25 is a case where the output unit 25 receives an instruction regarding a design of a novelty product of the real store from the user terminal 13.

In a case where the history information acquisition unit 23 acquires the information on the click rate with respect to links of products other than the products handled at the EC site as the information on the action history, the output unit 25 outputs information on a design of novelty products as the information on the design assistance of the real store.

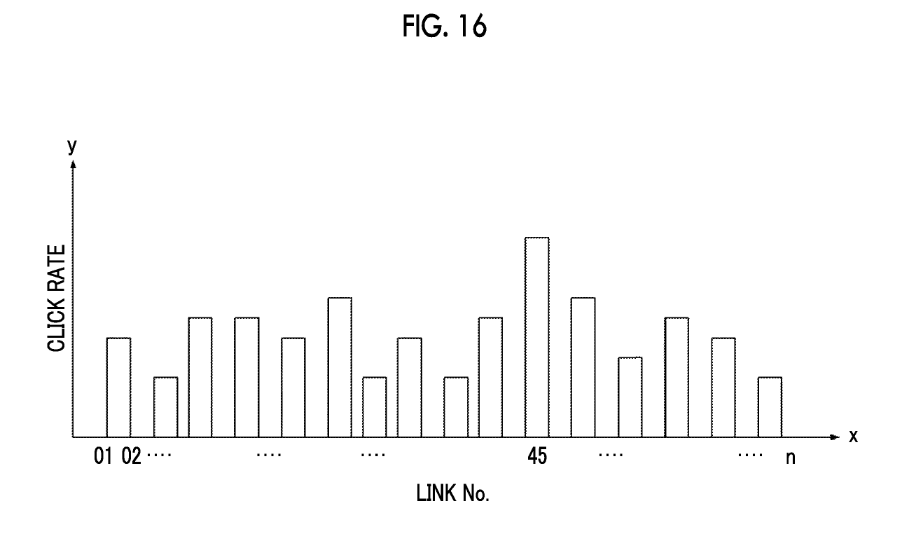

FIG. 16 is a graph showing information on a design of a novelty product, which is output from the output unit 25 and displayed on the display unit 126 of the user terminal 13. In FIG. 16, an x-axis indicates link No and a y-axis indicates the click rate.

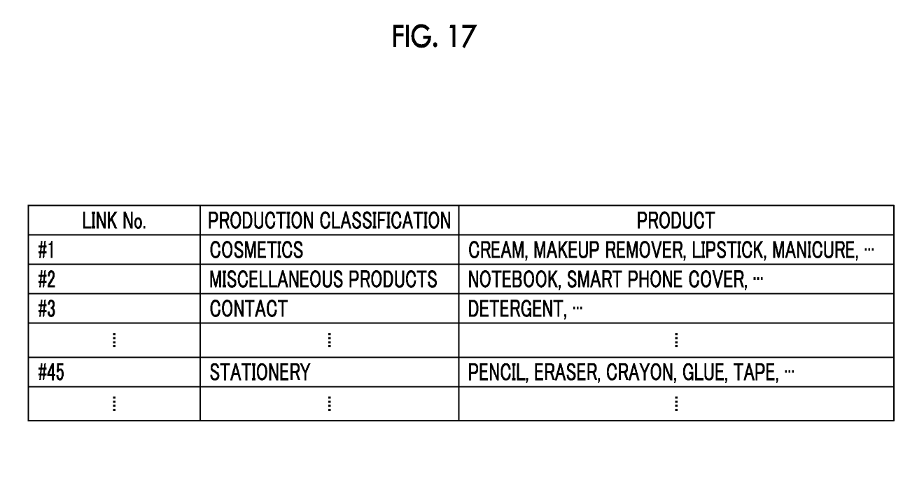

Further, FIG. 17 is a diagram illustrating a product classification and a product regarding the link No illustrated in FIG. 16. As illustrated in FIG. 17, the product classification and the product are associated with each link number.

For example, the user sets the product classification or the product with link No 45 as a novelty product in consideration of the click rate of link No 45 being high. That is, the user can perform a store design corresponding to the preference of the consumer who is a target of the real store by designing a stationery which is the product classification of link No 45 as a novelty product.

### Fourth Example

A fourth example of the information on the design assistance of the real store output by the output unit 25 is a case where the output unit 25 receives an instruction regarding a design of arrangement of store clerks of the real store from the user terminal 13.

In a case where the history information acquisition unit 23 acquires preference information of the consumer of the EC site as information on the action history, the output unit 25 outputs information on an arrangement of store clerks of the real store as the information on the design assistance of the real store.

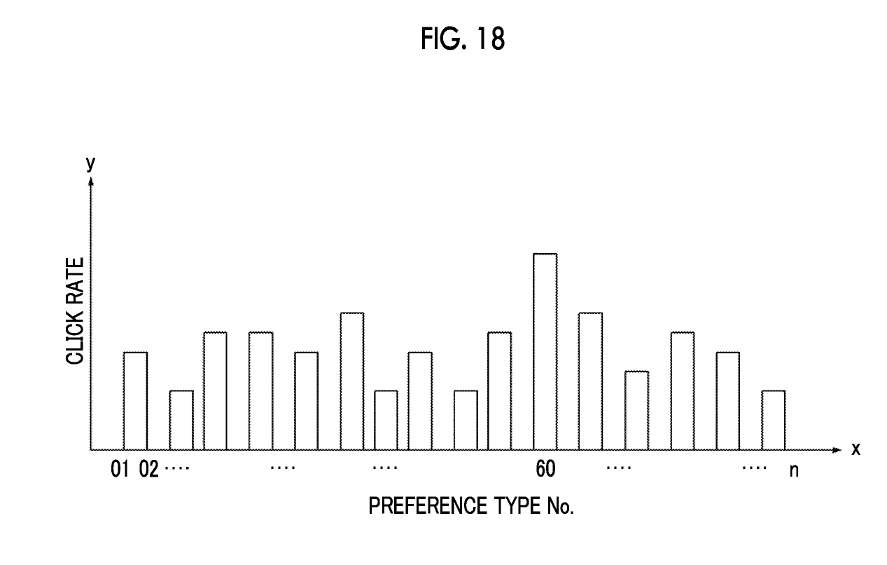

FIG. 18 is a graph showing preference information, which is output from the output unit 25 and displayed on the display unit 126 of the user terminal 13. In FIG. 18, an x-axis indicates a preference type No and a y-axis indicates the click rate.

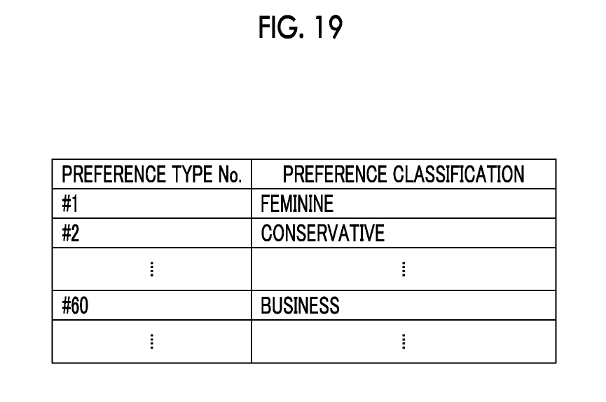

Further, FIG. 19 is a conceptual diagram illustrating a preference classification regarding a preference type No illustrated in FIG. 18. As illustrated in FIG. 19, a preference classification is assigned to each preference type No.

For example, the user can perform a store design according to the preference of the consumer who is a target of the real store by preferentially arranging store clerks talented in a business fashion of the preference type No 60 in consideration of the click rate of preference type No 60 being high.

Although the examples of the present invention have been described, it is apparent that the present invention is not limited to the embodiments described above, and various modifications can be made without departing from the spirit of the present invention.

### EXPLANATION OF REFERENCES

10: store design assistance device

11: consumer terminal

12: network

13: user terminal

21: attribute information acquisition unit

23: history information acquisition unit

25: output unit

26: consumer database

27: product database

29: database

30 communication unit

101: casing

102: touch panel display

103: operation button

104: speaker

105: built-in camera

106: external connection terminal

110: CPU

112: system bus

114: main memory

116: nonvolatile memory

118: mobile communication unit

118A: antenna

120: communication unit

120: wireless LAN communication unit

120A: antenna

122: near field wireless communication unit

122A: antenna

124: wired communication unit

126: display unit

128: input unit

130: key input unit

132: audio processing unit

134: image processing unit

step 10-step 12: store design assistance process

What is claimed is:

1. A store design assistance device, comprising:
a database in which first consumer attribute information indicating an attribute of a first consumer in an electronic commerce site and information on an action history of the first consumer are stored in association with each other;
an attribute information acquisition unit that acquires second consumer attribute information indicating an attribute of a second consumer at a real store;
a history information acquisition unit that acquires information on the action history of the first consumer having the first consumer attribute information matching the second consumer attribute information from the database; and
an output unit that outputs information on design assistance of the real store on the basis of the information on the action history acquired by the history information acquisition unit.

2. The store design assistance device according to claim 1,
wherein the history information acquisition unit acquires preference information of the first consumer as the information on the action history, and
the output unit outputs information on an arrangement of store clerks of the real store as the information on the design assistance of the real store.

3. The store design assistance device according to claim 1, wherein the first consumer attribute information and the second consumer attribute information include at least one of regional information, era information, or sex information.

4. The store design assistance device according to claim 2, wherein the first consumer attribute information and the second consumer attribute information include at least one of regional information, era information, or sex information.

5. The store design assistance device according to claim 1,
wherein the history information acquisition unit acquires information on a click rate of a product display as the information on the action history, and
the output unit outputs information on a purchase design of a product at the real store as the information on design assistance of the real store.

6. The store design assistance device according to claim 2,
wherein the history information acquisition unit acquires information on a click rate of a product display as the information on the action history, and
the output unit outputs information on a purchase design of a product at the real store as the information on design assistance of the real store.

7. The store design assistance device according to claim 3,
wherein the history information acquisition unit acquires information on a click rate of a product display as the information on the action history, and
the output unit outputs information on a purchase design of a product at the real store as the information on design assistance of the real store.

8. The store design assistance device according to claim 1, wherein the history information acquisition unit acquires information on a click rate of a product display posted on a top page of the electronic commerce site as the information on the action history, and
the output unit outputs information on a design of storefront display products at the real store as the information on design assistance of the real store.

9. The store design assistance device according to claim 2, wherein the history information acquisition unit acquires information on a click rate of a product display posted on a top page of the electronic commerce site as the information on the action history, and the output unit outputs information on a design of storefront display products at the real store as the information on design assistance of the real store.

10. The store design assistance device according to claim 3, wherein the history information acquisition unit acquires information on a click rate of a product display posted on a top page of the electronic commerce site as the information on the action history, and
the output unit outputs information on a design of storefront display products at the real store as the information on design assistance of the real store.

11. The store design assistance device according to claim 1,
wherein the history information acquisition unit acquires information on a click rate with respect to coordinated products display as the information on the action history, and
the output unit outputs coordinated exhibition information at the real store as the information on design assistance of the real store.

12. The store design assistance device according to claim 2,
wherein the history information acquisition unit acquires information on a click rate with respect to coordinated products display as the information on the action history, and
the output unit outputs coordinated exhibition information at the real store as the information on design assistance of the real store.

13. The store design assistance device according to claim 3,
wherein the history information acquisition unit acquires information on a click rate with respect to coordinated products display as the information on the action history, and
the output unit outputs coordinated exhibition information at the real store as the information on design assistance of the real store.

14. The store design assistance device according to claim 1,
wherein the history information acquisition unit acquires information on an order in which the products are viewed or coordinated as the information on the action history, and
the output unit outputs information on an arrangement of shelves or an arrangement of products at the real store as the information on design assistance of the real store.

15. The store design assistance device according to claim 2,
wherein the history information acquisition unit acquires information on an order in which the products are viewed or coordinated as the information on the action history, and
the output unit outputs information on an arrangement of shelves or an arrangement of products at the real store as the information on design assistance of the real store.

16. The store design assistance device according to claim 3,
wherein the history information acquisition unit acquires information on an order in which the products are viewed or coordinated as the information on the action history, and
the output unit outputs information on an arrangement of shelves or an arrangement of products at the real store as the information on design assistance of the real store.

17. The store design assistance device according to claim 1,
wherein the history information acquisition unit acquires information on a click rate with respect to a link of a product other than products handled by the electronic commerce site as the information on the action history, and
the output unit outputs information on a design of a novelty product as the information on design assistance of the real store.

18. The store design assistance device according to claim 2,
wherein the history information acquisition unit acquires information on a click rate with respect to a link of a product other than products handled by the electronic commerce site as the information on the action history, and
the output unit outputs information on a design of a novelty product as the information on design assistance of the real store.

19. The store design assistance device according to claim 3,
wherein the history information acquisition unit acquires information on a click rate with respect to a link of a product other than products handled by the electronic commerce site as the information on the action history, and
the output unit outputs information on a design of a novelty product as the information on design assistance of the real store.

20. A store design assistance method in which a database in which first consumer attribute information indicating an attribute of a first consumer in an electronic commerce site and information on an action history of the first consumer are stored in association with each other is used, the store design assistance method comprising steps of:
acquiring second consumer attribute information indicating an attribute of a second consumer at a real store;
acquiring information on the action history of the first consumer having the first consumer attribute information matching the second consumer attribute information from the database; and
outputting information on design assistance of the real store on the basis of the information on the action history.
